(19) United States
(12) Patent Application Publication
(10) Pub. No.: US 2017/0106406 A1
(43) Pub. Date: Apr. 20, 2017

(54) METHOD FOR MANUFACTURING ZINC OXIDE FILMS

(71) Applicants: NEC TOKIN Corporation, Sendai-shi (JP); Tokyo Institute of Technology, Tokyo (JP)

(72) Inventors: Nobuhiro Matsushita, Tokyo (JP); Yuto Seino, Tokyo (JP)

(21) Appl. No.: 15/207,413

(22) Filed: Jul. 11, 2016

(30) Foreign Application Priority Data
Oct. 16, 2015 (JP) 2015-204489

(51) Int. Cl. B05D 3/06; B05D 1/02; B05D 1/00

(52) U.S. Cl. CPC B05D 3/065; B05D 1/005; B05D 1/02

(57) ABSTRACT

A method for manufacturing zinc oxide films according to the present invention includes: a step (Step 1) for mixing zinc salt, aqueous ammonia, and organic acid to prepare a source solution containing a zinc ammine complex; a step (Step 2) for depositing a zinc oxide film on a substrate using the source solution by a liquid phase deposition method; and a step (Step 3) for irradiating the deposited zinc oxide film with UV light to remove the organic acid from the deposited zinc oxide film. The present invention can provide a method for manufacturing zinc oxide films that can simplify a device configuration of a manufacturing device.

### INCORPORATION BY REFERENCE

This application is based upon and claims the benefit of priority from Japanese patent application No. 2015-204489, filed on Oct. 16, 2015, the disclosure of which is incorporated herein in its entirety by reference.

### BACKGROUND OF THE INVENTION

1. Field of the Invention

The present invention relates to a method for manufacturing zinc oxide films and to, in particular, a method for manufacturing zinc oxide films using the Liquid Phase Deposition (LPD) method.

2. Description of Related Art

Recently, use of zinc oxide (ZnO), which material is low in cost, as a replacement for tin-doped indium oxide (ITO) containing rare elements as a material for transparent electrodes has been examined. ZnO exhibits n-type conductivity because of oxygen deficiency or interstitial zinc. It is known that the conductivity of ZnO can be improved by doping an element of group IV such as Al, Ga, or the like as a dopant. The conductive ZnO films with resistivity of the order of 10⁻⁴ Ω·cm have been prepared so far by using sputtering and ion plating.

One of film deposition methods for conductive ZnO films is a vapor phase method such as sputtering and ion plating. However, the manufacturing cost of the vapor phase method such as sputtering can be excessively high because such a method includes a process that requires a large vacuum device. Further, such a method is not suitable for increasing areas of films and mass production of films.

Japanese Unexamined Patent Application Publication No. 2012-144384 discloses a technique related to a method for manufacturing zinc oxide films using the LPD method. The technique disclosed in Japanese Unexamined Patent Application Publication No. 2012-144384 teaches a method for manufacturing conductive zinc oxide films, which includes: depositing a zinc oxide film on a substrate by the LPD method in the presence of organic acid; and irradiating the substrate with UV light to remove the organic acid from the zinc oxide film. Such a technique can provide a method for manufacturing conductive ZnO films that achieves an increase in areas of the films and mass production of the films at a low cost and a reduced environmental impact.

In the technique disclosed in Japanese Unexamined Patent Application Publication No. 2012-144384, two source solutions, which are a zinc nitrate aqueous solution and an ammonia aqueous solution containing citric acid, are separately prepared, the source solutions are separately transferred to a substrate, and the source solutions are mixed on the substrate (on a reaction field), so that a zinc oxide film is formed on the substrate.

### SUMMARY OF THE INVENTION

However, the present inventors have found a problem in such a configuration that separately transfers two source solutions to a substrate in that two transfer paths for the source solutions need to be prepared, thereby complicating a device configuration of a manufacturing device.

In light of the above circumstances, an object of the present invention is to provide a method for manufacturing zinc oxide films that can simplify a device configuration of a manufacturing device.

In an exemplary aspect of the present invention, a method for manufacturing zinc oxide films includes steps of: mixing zinc salt, aqueous ammonia, and organic acid to prepare a source solution containing a zinc ammine complex; depositing a zinc oxide film on a substrate using the source solution by a liquid phase deposition method; and irradiating the deposited zinc oxide film with UV light to remove the organic acid from the deposited zinc oxide film.

According to the present invention, it is possible to provide a method for manufacturing zinc oxide films that can simplify a device configuration of a manufacturing device.

The above and other objects, features and advantages of the present invention will become more fully understood from the detailed description given hereinbelow and the accompanying drawings which are given by way of illustration only, and thus are not to be considered as limiting the present invention.

### BRIEF DESCRIPTION OF THE DRAWINGS

FIG. 1 is a flowchart for explaining a method for manufacturing zinc oxide films according to an exemplary embodiment;

FIG. 2 is a drawing showing an example of a manufacturing device for achieving the method for manufacturing zinc oxide films according to the exemplary embodiment;

FIG. 3 is a flowchart for explaining a method for manufacturing zinc oxide films according to an example;

FIG. 4 is a graph showing a transmittance of the zinc oxide films for different wavelengths;

FIG. 5 is photographs indicating transparency of the zinc oxide films;

FIG. 6 is Scanning Electron Microscope (SEM) photographs of the zinc oxide films; and

FIG. 7 is a table showing resistivity, carrier concentrations, and mobility of the zinc oxide films.

### DESCRIPTION OF THE EXEMPLARY EMBODIMENTS

Hereinafter, an exemplary embodiment of the present invention will be described with reference to the drawings.

A method for manufacturing zinc oxide films according to this exemplary embodiment uses Liquid Phase Deposition (LPD) method. The LPD method is a method for depositing the crystals of metal oxide from an aqueous solution. By the LPD method, a crystalline thin film of metal oxide can be formed on a surface of a substrate by causing a synthesis reaction of the metal oxide in the aqueous solution and then depositing the crystals of the metal oxide directly on the substrate. According to the LPD method, the crystalline thin film of the metal oxide can be formed under a condition of a relatively low temperature of not more than 100 Celsius degrees, and thus the heat treatment process for the crystallization such as the sol-gel method will become unnecessary.

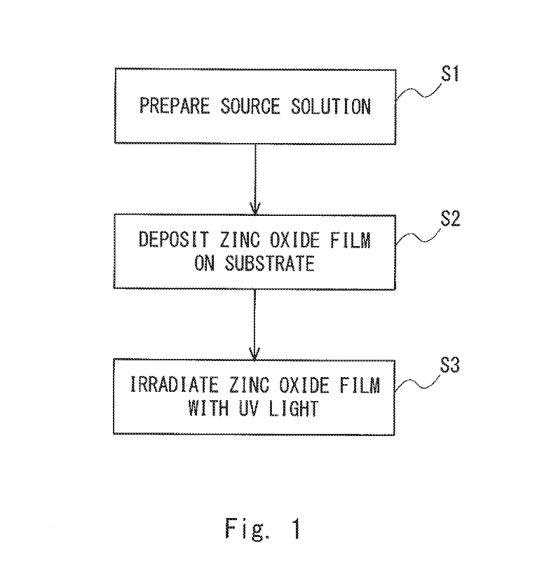

FIG. 1 is a flowchart for explaining a method for manufacturing zinc oxide films according to this exemplary embodiment. As shown in FIG. 1, the method for manufacturing zinc oxide films according to this exemplary embodiment includes a process (step S1) for preparing a source solution, a process (step S2) for depositing a zinc oxide film on a substrate, and a process (step S3) for irradiating the zinc oxide film with UV light. The respective processes will be described in detail below.

### Step S1: Process for Preparing Source Solution

Firstly, zinc salt, aqueous ammonia, and organic acid are mixed to prepare a source solution containing a zinc ammine complex. As the zinc salt according to this exemplary embodiment, zinc nitrate [Zn(NO₃)₂], zinc sulfate [ZnSO₄], zinc chloride [ZnCl₂], or hydrate of these zinc salts (e.g., Zn(NO₃)₂.nH₂O (n is natural number)) may be used. For example, when zinc nitrate [Zn(NO₃)₂] is used as the zinc salt, zinc nitrate in the mixed solution is ionized into divalent ions as shown in the following equation (1).

[Equation 1]

Zn(NO₃)₂+aq→Zn²⁺+2NO₃⁻ (1)

Further, the aqueous ammonia is equilibrated as shown in the following equation (2).

[Equation 2]

NH₃+H₂O→NH⁴⁺+OH⁻ (2)

The divalent zinc ions (Zn²⁺) in the equation (1) and hydroxide ions (OH⁻) in the equation (2) are reacted as shown in the following equation (3), and zinc hydroxide (Zn(OH)₂) is formed.

[Equation 3]

Zn²⁺+2OH⁻→Zn(OH)₂↓ (3)

The zinc hydroxide (Zn(OH)₂) is reacted with aqueous ammonia as shown in the following equation (4), and a zinc ammine complex (tetraammine zinc ion complex) is generated.

[Equation 4]

Zn(OH)₂+4NH₃→[Zn(NH₃)₄]²⁺+2OH⁻ (4)

In the invention according to this exemplary embodiment, organic acid is mixed in the process for preparing the source solution. The organic acid is a substance for controlling an orientation of ZnO crystals. As for growth rates of crystallographic planes of ZnO in the aqueous solution, in most cases, a growth rate of a plane (0001) of ZnO crystal in an aqueous solution is the highest among other planes of ZnO. In such a state, the needle-like crystals showing anisotropic growth in the c-axis direction are randomly jumbled up on the substrate to form the needle point holder, and thus a uniform film structure may not be obtained. However, a dense crystalline film can be obtained by adding a substance that is absorbed on the plane (0001) of ZnO to the deposition reaction system so as to prevent the anisotropic growth in the c-axis direction. Organic acid containing a carboxylic group (COOH) can be used as a substance that is absorbed on the plane (0001) of ZnO.

In this exemplary embodiment, such organic acid may include, for example, citric acid (e.g., [C₆H₅O₇]³⁻ or salt thereof) and another acid such as maleic acid or dimelcaptosuccinic acid as the dicarboxylic acid and phenol phtalein or eosin-Y as the monocarboxylic acid, or sodium salt, ammonium salt, or amine salt thereof.

For example, in this exemplary embodiment, Zn(NO₃)₂.6H₂O may be used as the zinc salt, and C₆H₅O₇Na₃ may be used as the organic acid. In this case, C₆H₅O₇Na₃ may be added to 5 mM Zn(NO₃)₂.6H₂O so that a concentration of C₆H₅O₇Na₃ will become 10 mM or less. In other words, a concentration ratio of Zn(NO₃)₂.6H₂O to C₆H₅O₇Na₃ (i.e., [Zn(NO₃)₂.6H₂O]:[C₆H₅O₇Na₃]) may be adjusted within a range of 5:1 to 5:10. The reason for adding C₆H₅O₇Na₃ to become a concentration of 10 mM or less is that C₆H₅O₇Na₃ with a concentration greater than 10 mM will inhibit a zinc oxide film from being formed on the substrate.

More preferably, 1 to 4 mM of C₆H₅O₇Na₃ may be added to 5 mM Zn(NO₃)₂.6H₂O. In other words, a concentration ratio of Zn(NO₃)₂.6H₂O to C₆H₅O₇Na₃ (i.e., [Zn(NO₃)₂.6H₂O]:[C₆H₅O₇Na₃]) may be adjusted within a range of 5:1 to 5:4.

A concentration of the ammonia is adjusted to become 140 mM or greater for, for example, 5 mM Zn(NO₃)₂.6H₂O. In other words, the concentration of the ammonia is adjusted in such a way that a concentration ratio of ammonia to the Zn(NO₃)₂.6H₂O will become 28 (i.e., 28/1) or higher. As an ammine complex is not formed with a low ammonia concentration, a zinc oxide film will not be formed as well. It is thus necessary to adjust the concentration of the ammonia to be greater than or equal to a predetermined concentration. When the concentration of the ammonia is low, zinc hydroxide particles are generated, which cause a nozzle of a manufacturing device to be clogged.

### Step S2: Process for Depositing Zinc Oxide Film on Substrate

Next, a zinc oxide film is deposited on the substrate by the LPD method using the source solution prepared in the step S1. To be more specific, the substrate that is in contact with the source solution prepared in the step S1 is heated so that a temperature thereof will become an appropriate film deposition temperature (50 to 100 Celsius degrees). Then, a supersaturated state of the deposition reaction system is changed by the heat, and ZnO is directly deposited on the surface of the substrate as shown in the equation (5).

[Equation 5]

[Zn(NH₃)₄]²⁺+2OH⁻→ZnO↓+4NH₃+H₂O (5)

In this exemplary embodiment, as a crystallization reaction shown in the above equation (5) progresses in the presence of the organic acid, anisotropic growth in the c-axis direction of ZnO crystals is prevented, and thus a continuous dense ZnO crystalline film is formed on the surface of the substrate.

As has been described above, as the method for manufacturing zinc oxide films according to this exemplary embodiment using the LPD method does not require the heat treatment process, it can be applied not only to glass substrates and silicon substrates but also to plastic substrates.

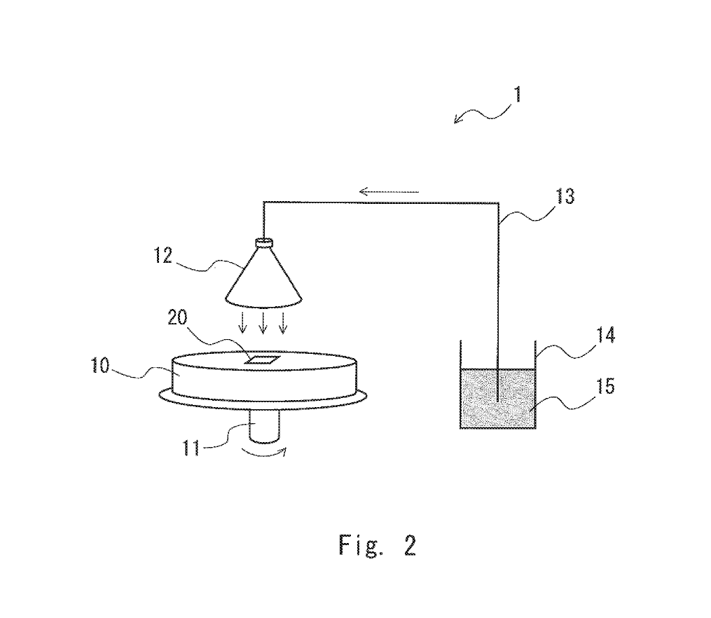

Note that the step S2 (the process for depositing a zinc oxide film on a substrate) in the method for manufacturing zinc oxide films according to this exemplary embodiment can be performed by the spin spray method. FIG. 2 is a drawing showing an example of a manufacturing device that carries out the method for manufacturing zinc oxide films according to this exemplary embodiment (step S2: process for depositing zinc oxide film on substrate). A spin spray device 1 shown in FIG. 2 includes a turntable 10, a rotation mechanism 11, a nozzle 12, a pipe 13, and a source container 14. The turntable 10 is coupled to the rotation mechanism 11. The turntable 10 can be rotated by rotating the rotation mechanism 11 at a predetermined rotation speed. The turntable 10 includes a heater that can heat a substrate 20 disposed on the turntable 10 to a predetermined temperature. The turntable 10 includes a mechanism that removes unnecessary products generated in the reaction and unnecessary source solutions.

The source container 14 holds a source solution 15 produced in the step S1. The source solution 15 held in the source container 14 is transferred through the pipe 13. The pipe 13 is connected to the nozzle 12. The source solution 15 transferred through the pipe 13 is uniformly sprayed from the nozzle 12 onto the substrate 20. In this manner, a zinc oxide film can be deposited on the substrate 20 using the spin spray device 1.

Note that the manufacturing device shown in FIG. 2 is merely an example, and in the method for manufacturing zinc oxide films according to this exemplary embodiment, any manufacturing device may be used as long as it can transfer a source solution to a substrate. That is, the process in the step S2 is not limited to the spin spray method, and any device may be used as long as the device includes a mechanism that heats a substrate, a mechanism that mixes the source solution prepared in the step S1 on the heated substrate, and a mechanism that removes unnecessary products generated in the reaction and supplied liquid that did not contribute to the reaction and thus becomes unnecessary.

Step S3: Process for Irradiating Zinc Oxide Film with UV Light

Next, the zinc oxide film deposited on the substrate is irradiated with UV light in order to remove the organic acid from the zinc oxide film deposited in the step S2. In the process for depositing the zinc oxide film on the substrate (step S2), the organic acid is incorporated into the film when a zinc oxide crystalline film is formed on the substrate. This consequently leads to a defect derived from the organic acid in the crystalline film, and the defect generates carriers. As the generated carriers are trapped in the organic acid, the zinc oxide crystalline film exhibits almost no conductivity when the step S2 is completed.

In the step S3, the organic acid incorporated into the crystalline film is removed using a photocatalytic activity of zinc oxide. That is, the organic acid in the film is photolyzed by irradiating the zinc oxide crystalline film with UV light. As a result, the carriers trapped in the organic acid are discharged inside the crystalline film, and then preferable conductivity is provided to the zinc oxide crystalline film. Note that the UV light to be used preferably has an appropriate wavelength taken a transmittance and the like into consideration so that the UV light reaches throughout the crystalline film in order to photolyze all the organic acid.

In the technique disclosed in Japanese Unexamined Patent Application Publication No. 2012-144384, two source solutions, which are a zinc nitrate aqueous solution and an ammonia aqueous solution containing citric acid, are separately prepared, the source solutions are separately transferred to a substrate, the source solutions are mixed on the substrate (on a reaction field), and then a zinc oxide film is formed. However, there is a problem in such a configuration that separately transfers two source solutions to a substrate in that two transfer paths for the source solutions need to be prepared, thereby complicating a device configuration of a manufacturing device.

Thus, in the method for manufacturing zinc oxide films according to this exemplary embodiment, in the process for preparing a source solution (step S1), zinc salt, aqueous ammonia, and organic acid are mixed to prepare a source solution containing a zinc ammine complex. Then, the source solution is transferred to the substrate to deposit a zinc oxide film (step S2). As there is only one source solution in the method for manufacturing zinc oxide films according to this exemplary embodiment, only one transfer path for the source solution is needed, thereby simplifying the device configuration of the manufacturing device.

Further, in the method for manufacturing zinc oxide films according to this exemplary embodiment, one source solution is transferred to the substrate to deposit a zinc oxide film on the substrate. It is therefore possible to form a zinc oxide film more uniformly than when two source solutions, which are a zinc nitrate aqueous solution and an ammonia aqueous solution containing citric acid, are separately transferred in order to form a zinc oxide film (see Japanese Unexamined Patent Application Publication No. 2012-144384).

As an example of characteristics of the zinc oxide film formed by the method for manufacturing zinc oxide films according to this exemplary embodiment, which has been explained above, a resistivity is within a range of 1.3×10⁻² to 9.1×10⁻¹ (Ω·cm), preferably 1.31×10⁻² to 9.19×10⁻¹ (Ω·cm), a transmittance at a film thickness 400 nm is within a range of 89 to 92(%), and the crystal structure is (002) oriented. To be more specific, an intensity ratio of X-ray diffraction (XRD) is (100):(002):(101)=0:9.5:1. That is, the (100) peak is not confirmed, there are mostly (002) peaks indicating the c-axis orientation, and a few (101) peaks. In other words, a zinc oxide film preferentially oriented with the c-axis is obtained.

In this way, by the method for manufacturing zinc oxide films according to this exemplary embodiment, it is possible to form a uniform zinc oxide film and achieve a zinc oxide film with a high transmittance.

### Example

Hereinafter, an example of the present invention will be described.

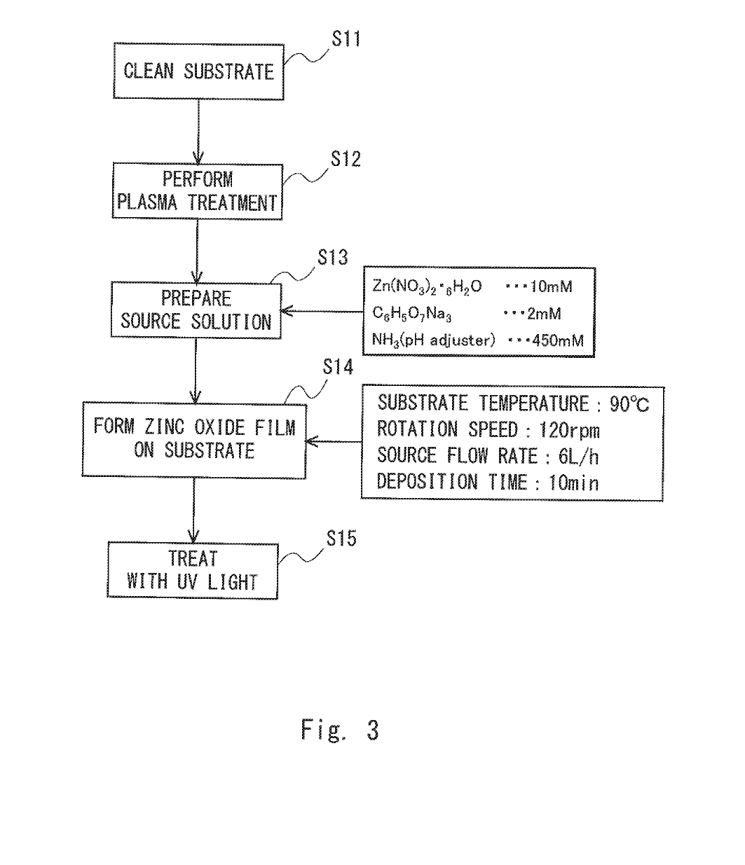

FIG. 3 is a flowchart for explaining a method for manufacturing zinc oxide films according to the example. In the method for manufacturing zinc oxide films according to the example, firstly a substrate was cleaned (step S11). A glass substrate was used as the substrate. The substrate was cleaned in water for ten minutes using an ultrasonic cleaner and then cleaned in ethanol for ten minutes using the ultrasonic cleaner. After that, a surface of the substrate was subjected to a plasma treatment for ten minutes (step S12). By the plasma treatment, hydroxyl groups that increase hydrophilicity were generated on the substrate.

Next, zinc salt, aqueous ammonia, and organic acid were mixed to prepare a source solution containing a zinc ammine complex (step S13). Zinc nitrate hexahydrate [Zn(NO₃)₂.6H₂O] was used as the zinc salt, and trisodium citrate [C₆H₅O₇Na₃] was used as the organic acid. More specifically, the source solution was adjusted so that a concentration of zinc nitrate hexahydrate [Zn(NO₃)₂.6H₂O] was 5 mM, a concentration of aqueous ammonia (NH₃) was 450 mM, and a concentration of trisodium citrate [C₆H₅O₇Na₃] was 2 mM.

Next, a zinc oxide film was formed on the substrate using the spin spray device 1 shown in FIG. 2 (step S14). To be more specific, the glass substrate, which has been subjected to the plasma treatment in the step S12, was disposed on the turntable 10 of the spin spray device 1, and the source solution was supplied onto the substrate. Deposition conditions are as follows: a substrate temperature was 90 Celsius degrees, a rotation speed of the turntable was 120 rpm, a flow rate of the source solution was 6 L/h, and a deposition time was ten minutes.

After that, the zinc oxide film produced in the step S14 is irradiated with UV light in order to remove the organic acid from the zinc oxide film. More specifically, the zinc oxide film was irradiated with UV light with a broad wavelength within a range of 300 to 400 nm using a black light for 24 hours.

In a comparative example, a zinc oxide film produced by the method disclosed in the related art (Japanese Unexamined Patent Application Publication No. 2012-144384), which uses two source solutions, was prepared. Samples of deposited zinc oxide films not irradiated with UV light were also prepared.

A result of an evaluation on the zinc oxide films produced as above will be described below.

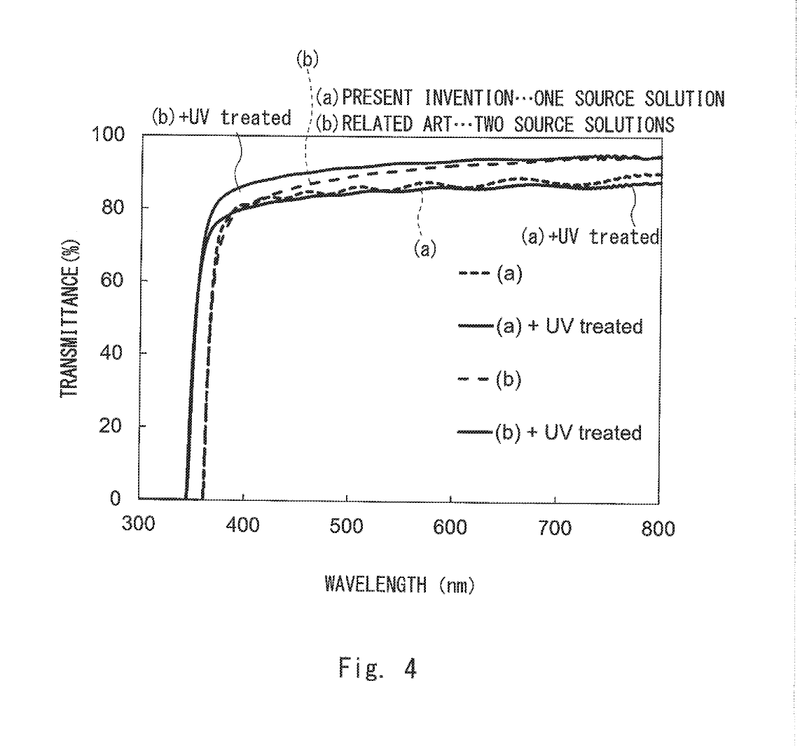

FIG. 4 is a graph showing a transmittance of the zinc oxide film for different wavelengths. As shown in FIG. 4, the transmittance for a wavelength within a range of about 380 nm to 800 nm was about 80% or greater both when the present invention (one source solution) is used and when the related art (two source solutions) was used. In the result shown in FIG. 4, although the transmittance when the related art (two source solutions) was used showed the transmittance higher than the transmittance when the present invention (one source solution) was used, a difference in the transmittance is small, namely, only a few %. Accordingly, a zinc oxide film with a sufficiently high transmittance was obtained when the present invention (one source solution) was used. With the UV treated films, absorption wavelengths were shifted to a low wavelength side both when the present invention (one source solution) was used and when the related art (two source solutions) was used.

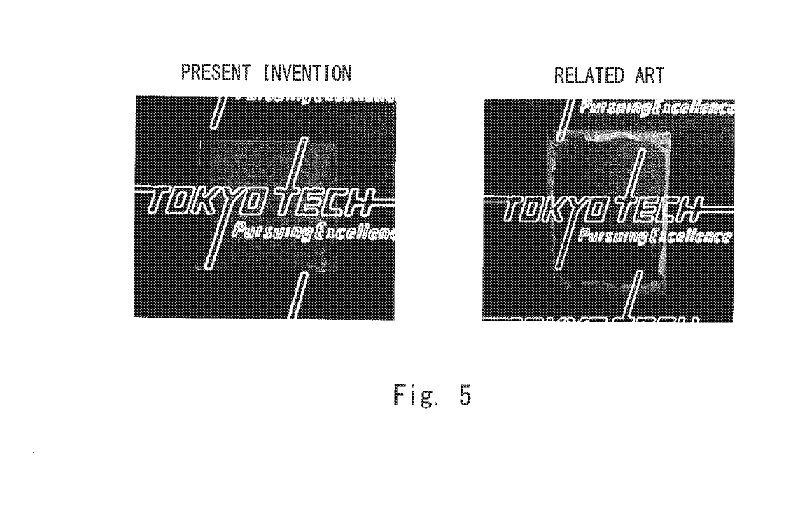

FIG. 5 shows photographs showing transparency of the zinc oxide films. As shown in FIG. 5, Characters behind the zinc oxide films (back of the drawing) are clearly confirmed both when the present invention (one source solution) was used and when the related art (two source solutions) was used. Thus, the zinc oxide films with high transparency were obtained.

X-ray diffraction measurements have been performed on these zinc oxide films. As a result, both of the zinc oxide films manufactured by the present invention (one source solution) and the related art (two source solutions) were crystallized. In a comparison between the zinc oxide films manufactured when the present invention (one source solution) was used and when the related art (two source solutions) was used, the (100) peak was the maximum when the related art (two source solutions) was used, whereas the (002) peak was the maximum when the present invention (one source solution) was used. As a result of examinations by the present inventors, it was found that the (100) peak was the maximum also in the present invention (one source solution) by adjusting the amount of citric acid to be added.

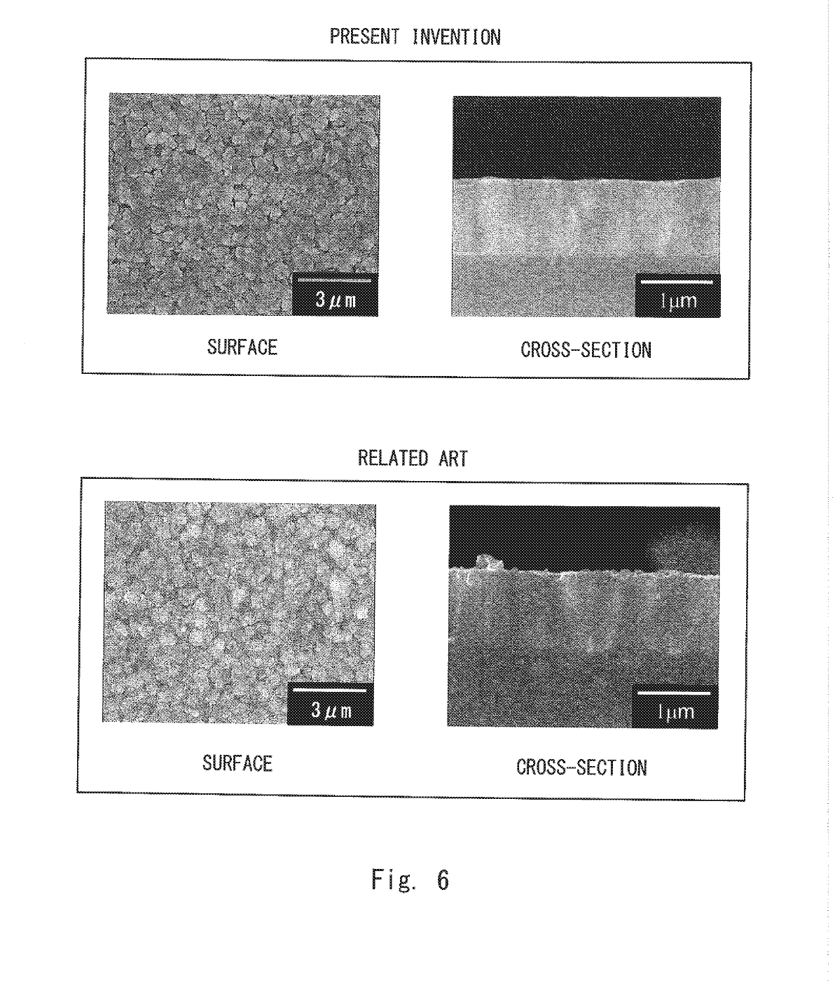

FIG. 6 shows Scanning Electron Microscope (SEM) photographs of the zinc oxide films. As shown in FIG. 6, a dense microstructure was obtained when the present invention (one source solution) was used in a manner similar to that when the related art (two source solutions) was used.

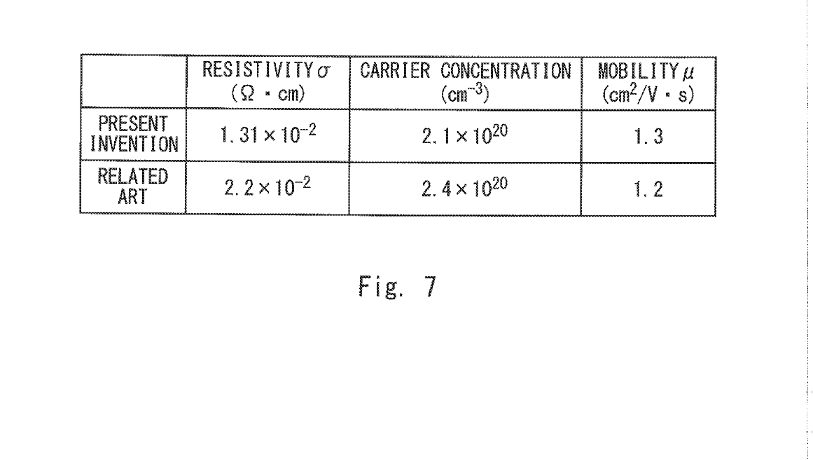

FIG. 7 is a table showing measurement results of resistivity, carrier concentrations, and mobility of the zinc oxide films. As shown in the table of FIG. 7, the resistivity when the present invention (one source solution) was used was 1.31×10⁻² (Ω·cm), which is smaller than 2.2×10⁻² (Ω·cm) that is the resistivity when the related art (two source solutions) was used. Moreover, the carrier concentration when the present invention (one source solution) was used was 2.1×10²⁰ (cm⁻³), which is smaller than 2.4×10²⁰ (cm⁻³) that is the carrier concentration when the related art (two source solutions) was used. Further, the mobility when the present invention (one source solution) was used was 1.3 (cm²/V·s), which is greater than 1.2 (cm²/V·s) that is the mobility when the related art (two source solutions) was used.

From the invention thus described, it will be obvious that the embodiments of the invention may be varied in many ways. Such variations are not to be regarded as a departure from the spirit and scope of the invention, and all such modifications as would be obvious to one skilled in the art are intended for inclusion within the scope of the following claims.

1. A method for manufacturing zinc oxide films comprising steps of:
mixing zinc salt, aqueous ammonia, and organic acid to prepare a source solution containing a zinc ammine complex;
depositing a zinc oxide film on a substrate using the source solution by a liquid phase deposition method; and
irradiating the deposited zinc oxide film with UV light to remove the organic acid from the deposited zinc oxide film.

2. The method for manufacturing the zinc oxide films according to claim 1, wherein Zn(NO₃)₂ or Zn(NO₃)₂.nH₂O (n is natural number) is used as the zinc salt, and [C₆H₅O₇]³⁻ or salt thereof is used as the organic acid.

3. The method for manufacturing the zinc oxide films according to claim 1, wherein Zn(NO₃)₂.6H₂O is used as the zinc salt, and C₆H₅O₇Na₃ is used as the organic acid.

4. The method for manufacturing the zinc oxide films according to claim 3, wherein a concentration ratio [Zn(NO₃)₂.6H₂O]:[C₆H₅O₇Na₃] is in a range of 5:1 to 5:10.

5. The method for manufacturing the zinc oxide films according to claim 4, wherein the concentration ratio [Zn(NO₃)₂.6H₂O]:[C₆H₅O₇Na₃] is in a range of 5:1 to 5:4.

6. The method for manufacturing the zinc oxide films according to claim 3, wherein a concentration ratio of ammonia to the Zn(NO₃)₂.6H₂O is 28 or higher.

7. The zinc oxide film produced using the method according to claim 1, wherein resistivity of the zinc oxide film is in a range of 1.3×10⁻² to 9.1×10⁻¹ (Ω·cm), and a transmittance of the zinc oxide film at a thickness of the zinc oxide film 400 nm is in a range of 89 to 92(%).
